(19) United States
(12) Patent Application Publication
(10) Pub. No.: US 2015/0039132 A1
(43) Pub. Date: Feb. 5, 2015

(54) COVER CONTROL METHOD AND PORTABLE COMPUTER USING SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: TONG-QI HUANG, Wuhan (CN); JIAN-HUNG HUNG, New Taipei (TW)

(21) Appl. No.: 14/444,263

(22) Filed: Jul. 28, 2014

(30) Foreign Application Priority Data
Aug. 1, 2013 (CN) 2013103325655

(51) Int. Cl. G06F 1/16; G06F 21/31; G05B 15/02; G06F 1/26

(52) U.S. Cl. CPC G06F 1/1616; G06F 1/26; G06F 21/31; G05B 15/02
USPC 700/275

(57) ABSTRACT

A cover control method for a portable computer is disclosed. The method includes: receiving a controlling signal from a portable electronic device when the Bluetooth pairing between the portable computer and the portable electronic device is successfully; controlling a cover of the portable computer to rotate relative to a base of the portable computer in response to the controlling signal and controlling the portable computer to perform a predetermined operation; detecting a rotation angel during the rotation process of the cover; determining whether the rotation angel of the cover is equal to a predetermined angle, and controlling the cover to stop rotating if the rotation angel of the cover is equal to a predetermined angle.

### CROSS-REFERENCE TO RELATED APPLICATIONS

This application claims priority to Chinese Application No. 201310332565.5 filed on Aug. 1, 2013 in the China Intellectual Property Office, the contents of which are incorporated by reference herein.

### FIELD

The subject matter herein generally relates to a method for controlling rotation of a cover of a portable computer and a portable computer using the method.

### BACKGROUND

Portable computers, including laptop computers or notebook computers, have increased in popularity since their introduction to the electronics market. Recent increases in processor speed and decreases in memory cost, memory size and processor power consumption have allowed portable computers to operate at increased performance levels. Because of this increased performance, users are now able to use portable computers in many complex applications where performance is critical instead of relying only on high performance desktop computers.

In general, a portable computer has a base unit and a display unit with a display screen. The display unit can be coupled with the base unit through a hinge assembly which allows the display unit to be rotated predetermined degrees relative to the base unit.

### BRIEF DESCRIPTION OF THE DRAWINGS

Implementations of the present technology will now be described, by way of example only, with reference to the attached figures, wherein:

FIG. 1 is an isometric diagram of an exemplary embodiment of a portable computer in an open configuration.

FIG. 2 is an isometric diagram of an exemplary embodiment of the portable computer in a closed configuration.

FIG. 3 is a block diagram of an exemplary embodiment of a portable computer in an example use environment.

FIG. 4 is a block diagram of an exemplary embodiment of a screen controlling system.

FIG. 5 is a flowchart of an exemplary embodiment of a screen control method for a portable computer.

FIG. 6 is a flowchart of an exemplary embodiment of an unlocking method for a portable computer.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a method of controlling a portable computer's screen to rotate automatically.

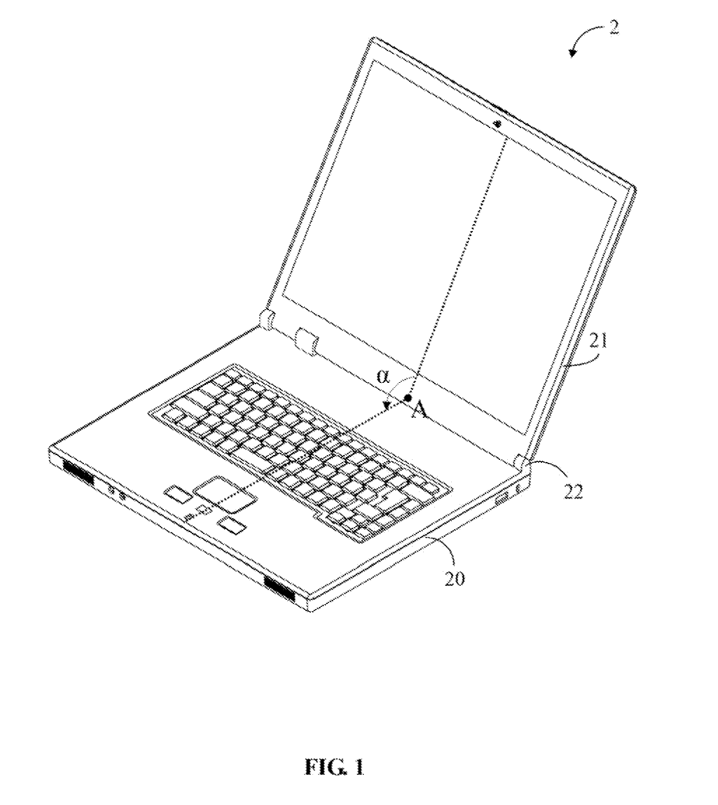

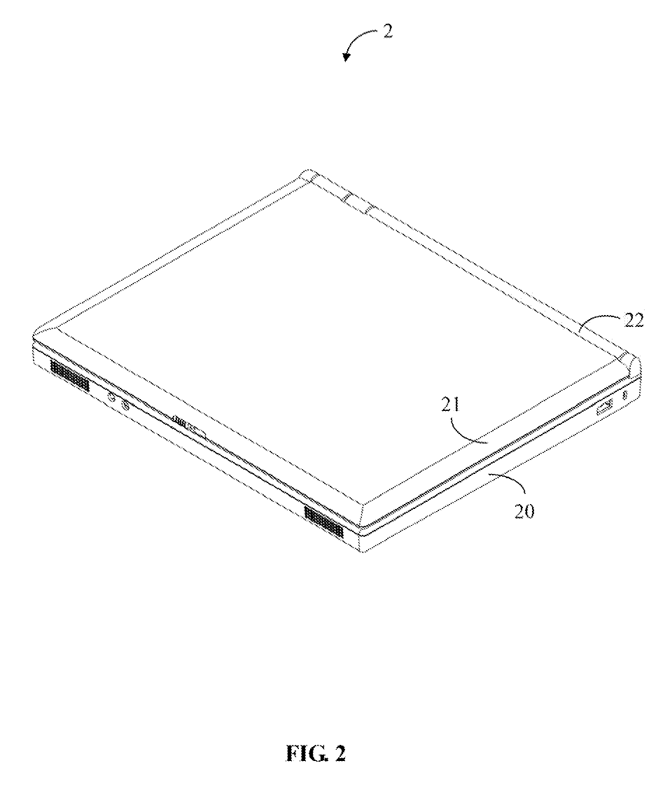

FIG. 1 illustrates a schematic diagram of an exemplary embodiment of a portable computer 2 in an open configuration, and FIG. 2 illustrates a schematic diagram of an exemplary embodiment of a portable computer 2 in a closed configuration. The portable computer 2 can includes a base 20 and a cover 21. The cover 21 can be pivotally coupled to the base 20 by a connection mechanism 22. The connection mechanism 22 can be configured at the intersection of the base and the cover and can be a hinge. The cover 21 can be configured to rotate relative to the base 20. A rotation angel can be equal to or greater than zero degree. The rotation angel has a vertex on the mechanism 22. The cover 21 can be transitionable between: (i) an open configuration in which the cover can be positioned at a predetermined rotation angle α greater than zero degree relative to the base 20; and (ii) a closed configuration in which the rotation angel equals to zero degree and the cover 21 covers the base 20.

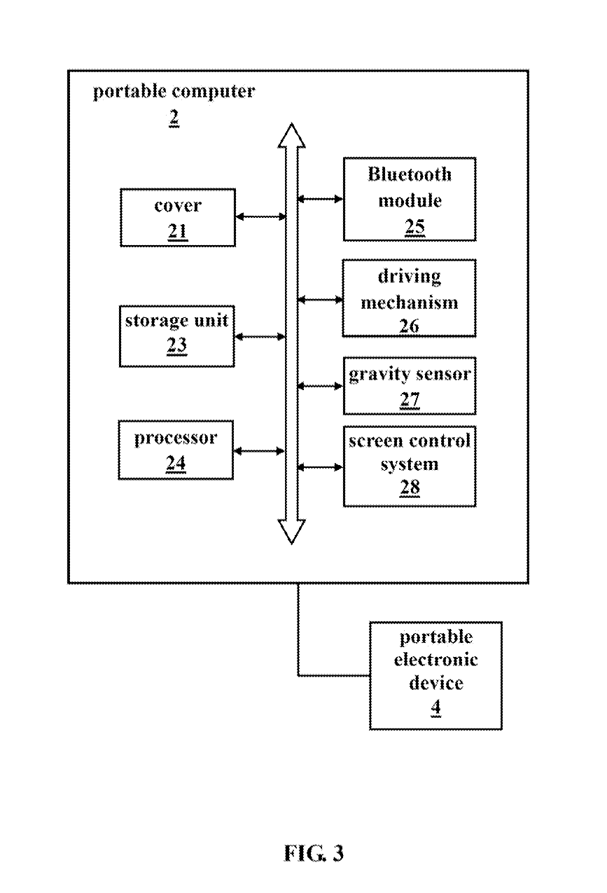

FIG. 3 illustrates a schematic block diagram of an exemplary embodiment of a portable computer in an example use environment. The portable computer 2 can be coupled to a portable electronic device by a Bluetooth module 25. The portable electronic device can be a mobile phone, a tablet computer, a Palm PC, a personal digital assistant, or any of a variety of other types of portable electronic device having a Bluetooth module. The portable computer 2 can include a storage unit 23 and a processor 24. The storage unit 23 can be configured to storing data or operating system or application programs. The processor 24 can be configured to perform the operating system or application programs. The portable computer 2 can further include a driving mechanism 26 and a gravity sensor 27. The driving mechanism 26 can be configured to drive the cover 21 to rotate relatively to the base 20. The gravity sensor 27 can be configured to detect a rotation angel of the cover 21. A cover controlling system 28 can include computerized instructions in the form of one or more programs that are executed by the processor 24 and stored in the storage unit 23.

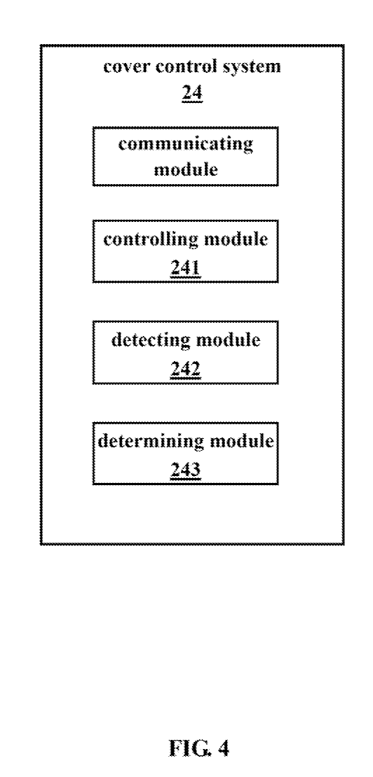

FIG. 4 illustrates a block diagram of an exemplary embodiment of the cover controlling system 28. The cover controlling system 28 can include one or more modules, for example, a communicating module 240, a controlling module 241, a detecting module 242, and a determining module 243. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The communicating module 240 can be configured to receive a controlling signal from a portable electronic device when the Bluetooth pairing between the portable computer and the portable electronic device is successfully. The controlling module 241 can be configured to control a cover of a portable computer to rotate in response to the controlling signal and configured to control the portable computer to perform a predetermined operation. The detecting module 242 can be configured to detect a rotation angel relative to a base of the portable computer. The determining module 243 can be configured to determine whether the rotation angel of the cover is equal to a predetermined angle α. The controlling module 241 can be configured to control the cover of a portable computer to stop rotating if the rotation angel of the cover is equal to the predetermined angle α. In other embodiments, the communicating module 240 further can be configured to transmit a request for entering a username and a password to the portable electronic device and to receive a username and a password from the portable electronic device.

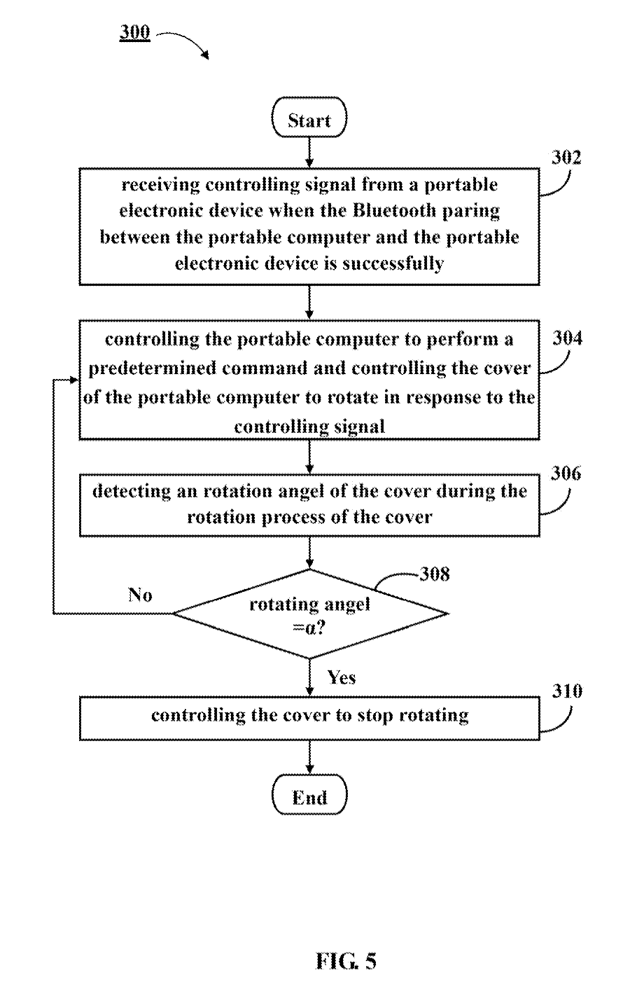

Referring to FIG. 5, a flowchart is presented in accordance with an example embodiment which is being thus illustrated. The example method 300 is provided by way of example, as there are a variety of ways to carry out the method. The method 300 described below can be carried out using the configurations illustrated in FIGS. 1, 2, 3, and 4, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 302.

At block 302, a portable computer receives a controlling signal from a portable electronic device when the Bluetooth pairing between the portable computer and the portable electronic device is successfully.

At block 304, a cover of the portable computer is controlled to rotate relative to a base of the portable computer and the portable computer is controlled to perform a predetermined operation in response to the controlling signal.

At block 306, a gravity sensor of the portable computer detects a rotation angel during the rotation process of the cover.

At block 308, the portable computer determines whether the rotation angel of the cover is equal to a predetermined angle α.

At block 310, the cover is controlled to stop rotating if the rotation angel of the cover is equal to a predetermined angle α. The predetermined operation can be power on or power off.

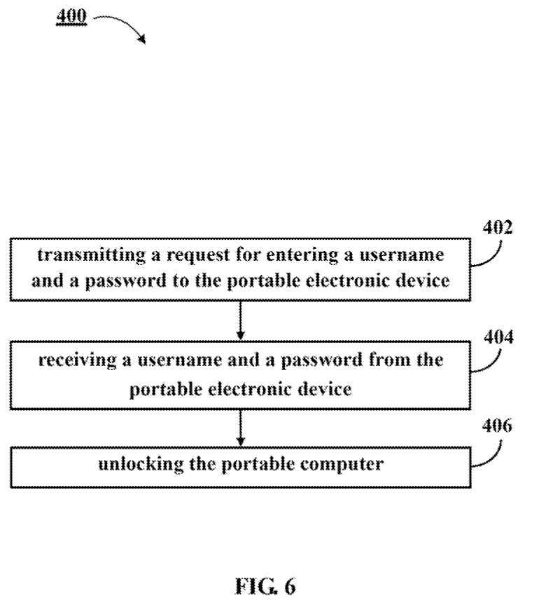

In other embodiments, if the portable computer is powered on and locked, referring to FIG. 6, an unlocking method 400 is illustrated.

At block 402, a request for entering a username and a password is transmitted to the portable electronic device.

At block 404, the portable computer receives a username and a password from the portable electronic device.

At block 406, upon receiving a username and a password from the portable electronic device, the portable computer is unlocked.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cover control method for a portable computer, the method comprising:
receiving a controlling signal from a portable electronic device when a Bluetooth pairing between the portable computer and the portable electronic device is successful;
controlling a cover of the portable computer to rotate relative to a base of the portable computer in response to the controlling signal;
detecting a rotation angle of the cover relative to the base during the rotation process of the cover;
determining whether the rotation angle of the cover is equal to a predetermined angle, and
controlling the cover to stop rotating and controlling the portable computer to perform a predetermined operation if the rotation angel of the cover is equal to a predetermined angle.

2. The method according to claim 1, wherein the predetermined operation is power on or power off.

3. The method according to claim 1, wherein the predetermined angle equals zero degree and the predetermined operation is power off.

4. The method according to claim 1, wherein the predetermined angle is greater than 0 and the predetermined operation is power on.

5. The method according to claim 1, wherein when the portable computer is powered on and the portable computer is locked, the method further comprising:
transmitting a request for entering a username and a password to the portable electronic device;
receiving a username and a password from the portable electronic device;
unlocking the portable computer.

6. The method according to claim 5, wherein the request and the username and the password is transmitted by Bluetooth.

7. A portable computer, comprising:
a base;
a cover configured to be coupled to the base and configured to be transitionable between: an open configuration in which the cover is positioned at a first predetermined angle greater than zero degree relative to the base; and a closed configuration in which the cover is positioned at zero degree angle;
a Bluetooth module;
a storage unit for storing instructions;
a processor for executing the instructions to performing a method, the method comprising:
receiving data from a portable electronic device when a Bluetooth pairing between the portable computer and the portable electronic device is successfully;
controlling a cover of the portable computer to rotate relative to a base of the portable computer in response to the controlling signal and controlling the portable computer to perform a predetermined operation;
detecting a rotation angel during the rotation process of the cover;
determining whether the rotation angel of the cover is equal to a second predetermined angle, and
controlling the cover to stop rotating if the rotation angel of the cover is equal to a second predetermined angle.

8. The portable computer according to claim 7, wherein the predetermined operation is powered on or powered off.

9. The portable computer according to claim 7, wherein the second predetermined angle is 0 and the portable computer is in the closed configuration.

10. The portable computer according to claim 7, wherein the second predetermined angle is greater than 0 and equal to the first predetermined angle, and the predetermined operation is power on.

11. The portable computer according to claim 10, wherein when the portable computer is powered on and the portable computer is locked, the method further comprising:
transmitting a request for entering a username and a password to the portable electronic device;
receiving a username and a password from the portable electronic device;
unlocking the portable computer.

12. The portable computer according to claim 11, wherein the request and the username and the password is transmitted by the Bluetooth module.

13. The portable computer according to claim 7, further comprising a driving unit configured to drive the cover to rotate.

14. A cover control method comprising:
establishing a Bluetooth connection between a portable computer and a portable electronic device, the portable computer comprising a base and a cover coupled together at a vertex by a hinge;
receiving, at the portable computer from the portable electronic device, a control signal, wherein the control signal configures the portable computer to rotate the cover at the hinge relative to the base;
detecting, at the portable computer, a rotation angle, wherein the rotation angle's vertex is the hinge at the intersection of the base and the cover;
configuring the portable computer to stop rotating when the rotation angle is equal to a pre-defined angle; and
configuring the portable computer to perform a predetermined operation.

15. The method according to claim 14, wherein the predetermined operation is powered on or powered off.

16. The method according to claim 14, wherein the pre-defined angle equals zero degree and the predetermined operation is powered off.

17. The method according to claim 14, wherein the pre-defined angle is greater than 0 and the predetermined operation is powered on.

18. The method according to claim 14, wherein when the portable computer is powered on and the portable computer is locked, the method further comprising:
transmitting a request for entering a username and a password to the portable electronic device;
receiving a username and a password from the portable electronic device;
unlocking the portable computer.
